(19) United States
(12) Patent Application Publication
(10) Pub. No.: US 2008/0172861 A1
(43) Pub. Date: Jul. 24, 2008

(54) METHODS FOR MANUFACTURING MOTOR CORE PARTS WITH MAGNETIC ORIENTATION

(76) Inventor: Alan G. Holmes, Clarkston, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/625,954

(22) Filed: Jan. 23, 2007

(51) Int. Cl. H01F 13/00; H02K 1/02; H02K 1/12; B22F 3/12; B22F 1/00; H01F 3/08; H02K 15/12

(52) U.S. Cl. 29/602.1; 335/284; 335/297; 310/254; 310/44; 419/26; 419/38; 148/108; 148/121

(57) ABSTRACT

Methods are provided for manufacturing a magnetizable core component for use in an electric motor. The method includes forming a green body from a powdered metal-ceramic composite. The method also includes heating the green body to form a core. The method further includes applying a magnetic field to the core to produce paths in a predetermined orientation, where the paths are configured to allow flux to flow therealong. The magnetizable core component is also provided.

### TECHNICAL FIELD

The present invention generally relates to components for use in electromagnetic devices, such as electric motors, and to methods of manufacturing the components with desired magnetic orientations and improved magnetic permeability.

### BACKGROUND

An electric motor generally includes a stator and a rotor. The stator is typically stationary, and the rotor rotates relative to the stator. In alternating current (“AC”) motors, the stator contains a current carrying component generating a magnetic field to interact with the rotor. The field generated by the stator propels or rotates the rotor relative to the stator.

In most cases, each of the stator or the rotor includes a core of material that is magnetizable and thus, capable of readily transmitting a magnetic field or flux along a predetermined path for the operation of the motor. The core is typically formed from a metal sheet that is punched into multiple suitably shaped laminations. The laminations are typically flat and circular, with multiple teeth extending inward or outward from a ring of back iron. These flat laminations are then stacked and bonded to each other to form the core of the stator and/or rotor. Next, the cores are made magnetizable by a magnetic field to create a desired path orientation therein. This magnetic field may alternate or may be moved relative to the core to thereby produce rotation and torque. In some instances, the metal sheet is made magnetizable during the construction and processing of the cores to provide desired predetermined paths for magnetic flux. Alternatively, the sheet is rolled in a particular manner such that the flux paths are disposed in a desired orientation.

While laminated stator cores are generally functional, they may not be used in certain space-limited motor designs. Specifically, when a short stacked core is produced from the laminations, the short stacked core yields less power while requiring a similar number of wire windings as compared with relatively longer stacked cores. Thus, the operating efficiency of these motors incorporating the short stacked cores may be relatively poor. To increase operating efficiency, additional components may be needed. However, the additional components may undesirably increase motor weight and cost. Moreover, producing laminated stator cores from rolled sheets limits the configuration of a stator or rotor to a cylinder, further limiting the shape and size of the space within which the stator or rotor may be implemented. Additionally, in some circumstances, magnetizing the laminated stator cores to form desired predetermined paths for flux may be relatively difficult.

Accordingly, there is a need for a method of manufacturing a core that is relatively simple to make magnetizable. It would be desirable for the magnetizable core to operate as efficiently in shorter motors as in longer motors without requiring additional components. Moreover, it would be desirable for the magnetizable core to be capable of being implemented into any motor design regardless of shape and size limitations. Furthermore, other desirable features and characteristics of the present invention will become apparent from the subsequent detailed description and the appended claims, taken in conjunction with the accompanying drawings and the foregoing technical field and background.

### SUMMARY

A method is provided for manufacturing a magnetizable core component for use in an electric motor. The method includes forming a green body from a powdered metal-ceramic composite. The method also includes heating the green body to form a core. The method further includes applying a magnetic field to the core to produce paths therein in a predetermined orientation, where the paths are configured to allow flux to flow therealong.

A magnetizable core component is also provided. The magnetizable core component is manufactured by a method that includes forming a green body from a powdered metal-ceramic composite, heating the green body to form a core, and applying a magnetic field to the core to produce paths therein in a predetermined orientation, where the paths are configured to allow flux to flow therealong.

### DESCRIPTION OF THE DRAWINGS

The present invention will hereinafter be described in conjunction with the following drawing figures, wherein like numerals denote like elements, and

FIG. 1 is a simplified, perspective view of an exemplary alternating current (“AC”) motor;

FIG. 2 is an end view of an exemplary stator core that may be implemented into the motor of FIG. 1;

FIG. 3 is a flow diagram illustrating a method of manufacturing a magnetizable core component that may be implemented into the motor of FIG. 1;

FIG. 4 is an exemplary portion of a stator core that may be manufactured during a step of the method shown in FIG. 3;

FIG. 5 is an exemplary simplified magnetizing device disposed within a core that may be used in the method shown in FIG. 3; and

FIG. 6 is another exemplary simplified magnetizing device with a core portion implemented therein that may be used in the method shown in FIG. 3.

### DESCRIPTION OF AN EXEMPLARY EMBODIMENT

The following detailed description is merely exemplary in nature and is not intended to limit the invention or the application and uses of the invention. Although the invention is described as being implemented in a motor, it will be appreciated that the invention may be applied to electromagnets in general and may be incorporated into any component that includes a magnetic core. Furthermore, there is no intention to be bound by any expressed or implied theory presented in the preceding technical field, background, brief summary or the following detailed description.

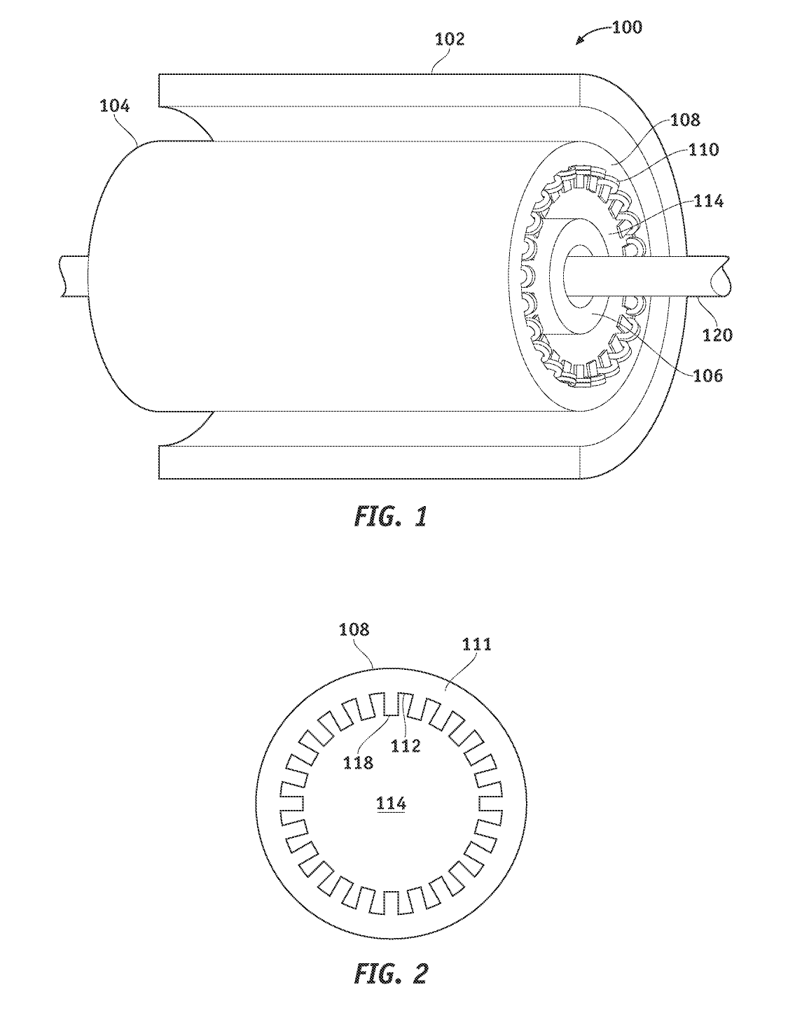

FIG. 1 is a perspective view of a simplified alternating current (“AC”) motor 100. The motor 100 includes a housing 102, a stator 104, and a rotor 106. The stator 104 is disposed within the housing 102 and includes a stator core 108 and windings 110. The stator core 108, shown more clearly in FIG. 2, has a back iron ring 111 including an inner surface 112 that defines a passage 114. The inner surface 112 includes teeth 118 that extend radially into the passage 114. Returning to FIG. 1, the windings 110, which electrically communicate with a power source (not shown), are wound around the teeth 118. The rotor 104 is disposed within the stator core passage 114 and is mounted to a shaft 120. During operation, current flowing through the windings 110 causes the stator core 108 to generate a magnetic field having one or more predetermined paths along which flux may travel. The paths may be disposed in a predetermined orientation. For example, in one embodiment, one predetermined path may extend from the rotor 106 across part of the passage 114 into the stator core 108 through some of the stator core teeth 118 around a portion of the back iron ring 111, and out the stator core 108 through one or more of the other stator core teeth 118. The magnetic field causes the rotor 104 to rotate relative to the stator core 108.

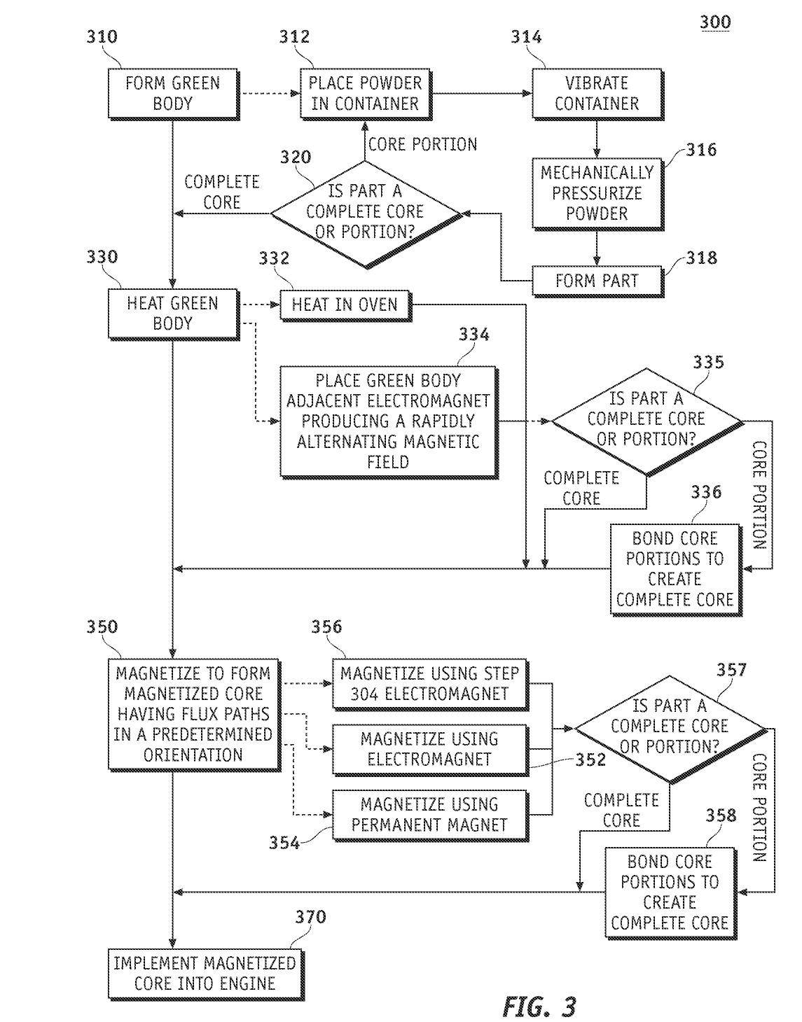

Although the stator 104 and rotor 106 may be manufactured via any one of numerous conventional processes, one exemplary method is depicted in FIG. 3. In this method 300, a metal-ceramic powder is first formed into a green, that is, unfired, body, step 310. The metal-ceramic powder may be any one of numerous suitable materials that includes at least a metal and a ceramic and that may be formed into a solid component having a desired magnetic orientation. Suitable materials include, but are not limited to, iron-silicon powder coated with ceramic material such as olivines (for example, fosterite). Olivines are complex oxides formed by reaction of iron-silicon steel with magnesium oxide during processing.

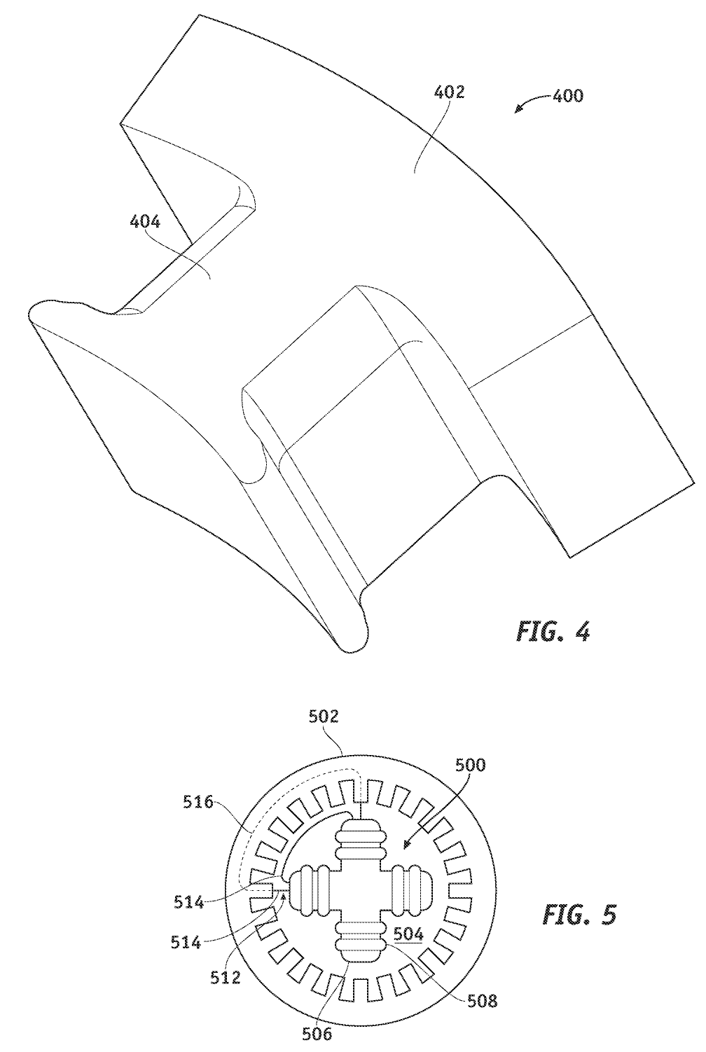

The green body may be formed using any one of numerous conventional processes. In one example, the metal-ceramic powder is first placed in a container having a shape complementary to the rotor 106, the stator core 108, or a portion of the rotor 106 or stator core 108, step 312. One exemplary core portion 400 is shown in FIG. 4. Here, the stator core portion 400 is shaped to include a portion 402 of the back iron ring 111 and one or more teeth 404. After the powder is disposed in a suitably shaped container, the container is vibrated to compact the powder therein, step 314. Next, the powder is subjected to mechanical pressurization, step 316. As a result, the powder bonds to itself and takes the shape of the container thereby forming a green body, step 318. In embodiments in which the container is shaped to complement a portion of the stator core 108 or rotor 106, steps 312, 314, 316, and 318 are repeated until a suitable number of green bodies needed to produce a complete stator core 108 or rotor 106 are formed, step 320.

Next, the green body is heated to a predetermined temperature to form a core or portion thereof, step 330. Any suitable heating process may be employed. In one exemplary embodiment, the green body is placed in an oven and heated, step 332. In another exemplary embodiment, the green body is disposed adjacent a magnetic fixture, such as an electromagnet, capable of producing a rapidly alternating magnetic field, step 334. The metal in the green body reacts to the alternating magnetic field to thereby increase the green body's temperature.

The predetermined temperature is substantially equal to or below a temperature at which the metal in the metal ceramic powder loses its ability to become magnetized. In embodiments in which the metal ceramic powder includes iron or paramagnetic material, the predetermined temperature is a temperature that is substantially equal to or below the Curie point of the iron or paramagnetic material. In some embodiments, the predetermined temperature may be the Curie point. In still other embodiments, the predetermined temperature may be substantially below the Curie point while still allowing complete re-alignment of the magnetic structures within the iron. Realignment results from a combination of energy from both the temperature and the imposed magnetic field. In embodiments in which step 310 is used to produce multiple core portions, step 335, this step may also be employed to bond the core portions together to form a complete stator core or rotor, step 336. In this embodiment, the predetermined temperature may be a temperature that is both slightly below a temperature at which the metal in the metal ceramic powder loses its ability to become magnetized and above the sintering temperature of the ceramic in the metal ceramic material.

The core (or any portion thereof) is then subjected to a magnetic field to form a magnetizable core component having paths therein in a predetermined orientation, wherein the paths are configured to allow flux to flow therealong, step 350. This step causes the magnetic structures within the metal of the core to re-align in the predetermined orientation to thereby form the desired paths. This step may be performed after or in conjunction with step 330, and is at least performed while the core cools to a temperature below the predetermined temperature. In some embodiments, the magnetic field is applied until the core cools to room temperature.

Any magnetic fixture capable of generating a magnetic field that emits field lines that flow along paths oriented in the predetermined path orientation may be used. A particular magnetic fixture may be selected based, in part, on whether a complete core or a portion of a core is to be magnetized. In one example, an electromagnet is used, step 352. FIG. 5 shows an end view of an exemplary electromagnetic, e.g. magnetic fixture 500, magnetizing a complete core 502. The magnetic fixture 500 is disposed within a passage 504 that extends through the core 502, and is configured to generate a magnetic field 512 having a field strength that is equal to or greater than the field strength of the magnetic field that will be emitted from the core 502. The magnetic fixture 500 includes a magnetizing core 506 and windings 508. To generate the desired magnitude of flux, the magnetizing core 506 may be made of specialized materials that may be relatively expensive to incorporate into motor core parts, such as magnetic alloys based on nickel or cobalt. The windings 508, which are wound around the magnetizing core 506, electrically communicate with a power source (not shown) so that when power is provided to the windings 508, current flows therethrough to generate the magnetic field 512. The magnetic field 512 flow from north to south along field lines 514 that flow in the predetermined orientation. Appropriate portions of the core 506 material align with the field lines 514 to create paths 516 therein having the predetermined orientation.

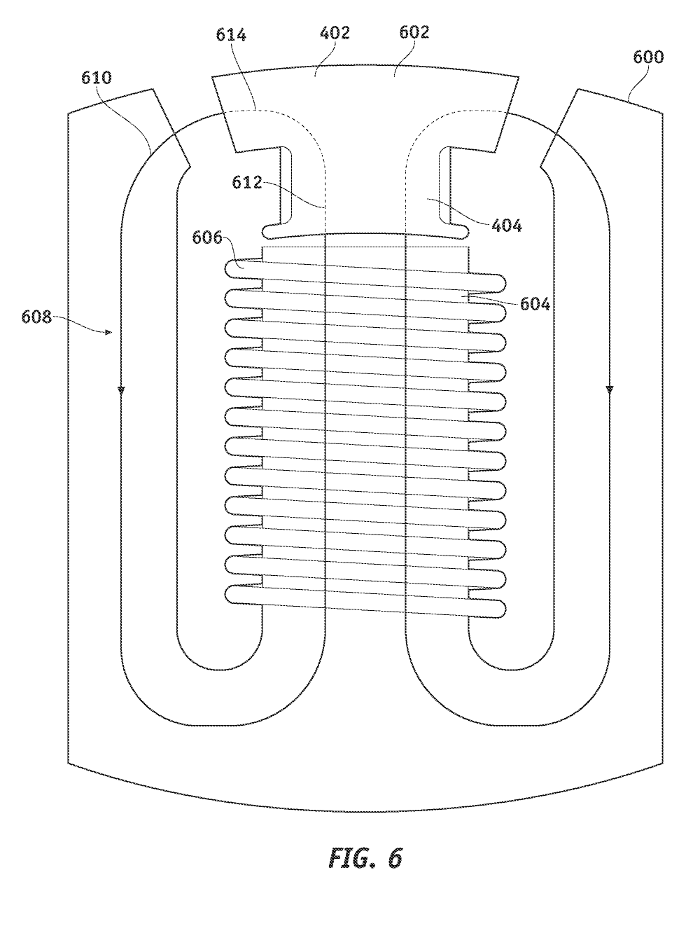

FIG. 6 shows an exemplary magnetic fixture 600 for magnetizing a core portion 602. The magnetic fixture 600 is an electromagnet including a core 604 and a winding 606 disposed therearound. The core portion 602 is placed adjacent to the magnetic fixture 600 and is subjected to a magnetic field 608 generated therefrom. The magnetic field 608 flows along field lines 610 flowing in the predetermined orientation that cause the material of the core portion 602 to create paths therein having the predetermined orientation. For example, as shown in FIG. 6, the paths may be formed such that the flux will be directed to flow through the at least one tooth 404 along a first direction 612 and the back iron ring portion 402 along a second direction 614 substantially perpendicular to the first direction 612. Although the above examples describe use of electromagnets, other types of magnets, such as permanent magnets, may alternatively be used, step 354. In some embodiments, the magnetic fixture used to heat the green body in step 330 above may be used in this step, step 356.

In embodiments in which core portions are magnetized (step 357), the core portions are subsequently bonded to form a complete stator core or rotor, step 358. Any one of numerous conventional bonding processes may be used. For example, the core portions may be placed adjacent one another and heated, or a suitable adhesive may be used to bond the core portions together. After the magnetic core is formed, it may be used in a manufacturing process of an electric motor, or alternatively, may be retrofitted into an existing electric motor, step 370.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of manufacturing a magnetizable core component for use in an electromagnetic device, the method comprising the steps of:
forming a green body from a powdered metal-ceramic composite;
heating the green body to form a core; and
applying a magnetic field to the core to produce the magnetizable core component having paths in a predetermined orientation, the paths configured to allow flux to flow therealong.

2. The method of claim 1, wherein the steps of heating the green body and applying a magnetic field to the core are performed simultaneously.

3. The method of claim 1, wherein:
the powdered metal-ceramic composite includes a metal material and the metal material has a Curie point;
the step of heating comprises heating the core to a predetermined temperature below the Curie point; and
the step of applying a magnetic field comprises applying a magnetic field while cooling the core to a temperature below the predetermined temperature.

4. The method of claim 1, wherein the step of heating comprises subjecting the green body to an alternating magnetic field generated by an electromagnet.

5. The method of claim 4, wherein the step of applying a magnetic field comprises exposing the core to a magnetic field generated by the electromagnet.

6. The method of claim 1, wherein the step of forming a green body comprises forming a green body from a powder comprising iron coated with a ceramic material.

7. The method of claim 1, wherein the magnetizable core component is configured to be used as a part of a stator for use in an electric motor and comprises a back iron and at least one tooth extending radially inwardly therefrom, the method further comprises:
forming a portion of the magnetizable core component, the magnetizable core component portion including at least one tooth and a portion of the back iron; and
cooling the magnetizable core portion and applying the magnetic field to the magnetizable core component portion such that magnetic flux flows through the at least one tooth along a first direction and the back iron portion along a second direction substantially perpendicular to the first direction.

8. The method of claim 1, wherein each core comprises a portion of the magnetizable core component and the method further comprises the steps of:
repeating the steps of forming, heating, and applying to form a plurality of core portions; and
bonding the core portions together to form the magnetizable core component.

9. The method of claim 8, wherein the step of bonding the core portions together is performed in conjunction with the step of heating.

10. The method of claim 1, further comprises:
performing the steps of heating and applying on a single device.

11. A method for manufacturing a magnetizable core component, the method comprising the steps of:
forming a plurality of green bodies from iron ceramic composite powder having a Curie point;
simultaneously heating the plurality of green bodies to a first predetermined temperature below the Curie point and bonding at least two of the plurality of green bodies with one another to create a core; and
applying a magnetic field to the core to produce the magnetizable core component having paths in a predetermined orientation, the paths configured to allow flux to flow therealong.

12. The method of claim 11, wherein:
the step of applying a magnetic field comprises applying a magnetic field while cooling the core to a second predetermined temperature below the Curie point.

13. The method of claim 11, wherein the step of simultaneously heating comprises subjecting the green body to an alternating magnetic field generated by an electromagnet.

14. The method of claim 13, wherein the step of applying a magnetic field comprises exposing the core to a magnetic field generated by the electromagnet.

15. The method of claim 11, wherein the magnetizable core component is configured to be used as part of a stator in an electric motor and comprises a back iron and at least one tooth extending radially inwardly therefrom, and the plurality of green bodies each comprise a portion of the magnetizable core component, the method further comprising the steps of:
forming at least one green body including at least one tooth and a portion of the back iron;
cooling the at least one green body during the step of applying the magnetic field to form at least one core portion; and
applying the magnetic field to the at least one core portion such that magnetic flux flows through the at least one tooth along a first direction and the back iron portion along a second direction substantially perpendicular to the first direction.

16. A magnetizable core component manufactured by a method comprising the steps of:
forming a green body from a powdered metal-ceramic composite;
heating the green body to form a core; and
applying a magnetic field to the core to produce the magnetizable core component having paths in a predetermined orientation, the paths configured to allow flux to flow therealong.

17. The magnetizable core component of claim 16, configured to be used as a part of a stator in an electric motor and further comprising a back iron and at least one tooth extending radially inwardly therefrom, the green body comprising a portion of the magnetizable core component, and the magnetizable core component manufactured by a method further comprising the steps of:
forming the green body to include at least one tooth and a portion of the back iron;
cooling the green body during the step of applying the magnetic field to form a core portion; and
applying the magnetic field to the core portion such that magnetic flux flows through the at least one tooth along a first direction and the back iron portion along a second direction substantially perpendicular to the first direction.

18. The magnetizable core component of claim 16, wherein:
the powdered metal-ceramic composite has a Curie point;
the step of heating comprises heating the core to a predetermined temperature below the Curie point; and
the step of applying a magnetic field comprises applying a magnetic field while cooling the core to a temperature below the predetermined temperature.
